(19) United States
(12) Patent Application Publication
(10) Pub. No.: US 2025/0118723 A1
(43) Pub. Date: Apr. 10, 2025

(54) METHOD OF MANUFACTURING CURRENT COLLECTOR FOIL

(71) Applicant: TOYOTA JIDOSHA KABUSHIKI KAISHA, Toyota-shi (JP)

(72) Inventors: Takahiko NAKANO, Nagoya-shi (JP); Yusuke KINTSU, Miyoshi-shi (JP)

(73) Assignee: TOYOTA JIDOSHA KABUSHIKI KAISHA, Toyota-shi (JP)

(21) Appl. No.: 18/895,415

(22) Filed: Sep. 25, 2024

(30) Foreign Application Priority Data
Oct. 10, 2023 (JP) 2023-175539

(51) Int. Cl. H01M 4/04

(52) U.S. Cl. CPC H01M 4/0404

(57) ABSTRACT

A first electrode foil having a pinhole, a second electrode foil, a method of manufacturing a current collector foil to obtain a current collecting foil for a liquid-based battery by laminating, the first electrode foil and the second electrode foil, one is a positive electrode foil, the other is a negative electrode foil, the application step of applying an adhesive to the first electrode foil, suction from the surface side opposite to the surface to which the adhesive is applied in the first electrode foil, a suctioning step of impregnating the adhesive into the pinhole, a drying step of drying the adhesive, and a heat welding step of thermal welding by bonding the second electrode foil to the surface to which the adhesive is applied in the first electrode foil, the method of manufacturing a current collector foil.

### CROSS-REFERENCE TO RELATED APPLICATION

This application claims priority to Japanese Patent Application No. 2023-175539 filed on Oct. 10, 2023, incorporated herein by reference in its entirety.

### BACKGROUND

### 1. Technical Field

The present disclosure relates to a method of manufacturing a current collector foil.

### 2. Description of Related Art

Conventionally, a current collector foil for a liquid-based battery in which a positive electrode foil and a negative electrode foil are bonded together has been used.

For example, Japanese Unexamined Patent Application Publication No. 2023-053669 (JP 2023-053669 A) discloses a bipolar current collector. The bipolar current collector includes a positive electrode current collector having an aluminum layer, a negative electrode current collector having a copper layer, and an intermediate layer interposed between the aluminum layer and the copper layer. The copper layer has a thickness of 3 to 10 μm. The intermediate layer has a porous alumite portion and a nickel portion present in the pores of the alumite portion.

Japanese Unexamined Patent Application Publication No. 2018-037247 (JP 2018-037247 A) discloses a stacked all-solid-state secondary battery. In the all-solid-state secondary battery, a positive electrode, a solid electrolyte layer, and a negative electrode are stacked to constitute an electrical parallel connection in a parallel electrode body. A plurality of parallel electrode bodies is electrically connected in series via a bipolar electrode. The bipolar electrode is disposed to face the positive electrode and the negative electrode, and a bipolar electrode current collector foil and a positive electrode current collector foil of the positive electrode and a negative electrode current collector foil of the negative electrode disposed to face the bipolar electrode are separated from each other.

### SUMMARY

Conventionally, a current collector foil in which a positive electrode foil and a negative electrode foil are bonded together via an adhesive has been used as a current collector foil for a liquid-based battery. However, pinholes may be formed in a process of manufacturing a metal foil to be used for the positive electrode foil and the negative electrode foil. When a current collector foil having pinholes in at least one of the positive electrode foil and the negative electrode foil is used for a liquid-based battery, a through hole may be formed to penetrate the positive electrode foil, the adhesive layer, and the negative electrode foil, and a liquid junction may occur through the through hole in the liquid-based battery.

The present disclosure has been made in view of the above circumstances, and an object thereof is to provide a method of manufacturing a current collector foil that can reduce the number of pinholes in the current collector foil.

Means for addressing the above issue include the following aspects.
<1> A method of manufacturing a current collector foil for a liquid-based battery by bonding a first electrode foil having a pinhole and a second electrode foil, one of the first electrode foil and the second electrode foil being a positive electrode foil and another being a negative electrode foil, the method including: an application step of applying an adhesive to the first electrode foil; a suctioning step of impregnating the pinhole with the adhesive by performing suctioning from a surface side opposite to a surface of the first electrode foil to which the adhesive has been applied; a drying step of drying the adhesive; and a heat welding step of performing heat welding by bonding the second electrode foil to the surface of the first electrode foil to which the adhesive has been applied.
<2> The method of manufacturing a current collector foil according to <1>, in which the suctioning step includes performing suctioning with a suction member having suction holes in a surface thereof in contact with the surface side opposite to the surface of the first electrode foil to which the adhesive has been applied.
<3> The method of manufacturing a current collector foil according to <2>, in which a diameter of the suction holes is 0.5 mm or more and 15 mm or less.
<4> The method of manufacturing a current collector foil according to <2>, in which a spacing of the suction holes is 1.0 mm or more and 20 mm or less.
<5> The method of manufacturing a current collector foil according to <2>, in which a pressure of suctioning from the suction holes is 5 kPa or more and 40 kPa or less.

According to the present disclosure, there is provided a method of manufacturing a current collector foil that can reduce the number of pinholes in the current collector foil.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a current collector foil manufacturing device that implements a method of manufacturing a current collector foil according to an embodiment of the present disclosure;

FIG. 2 is a schematic cross-sectional view showing a state in which an adhesive is impregnated in a pinhole in a suctioning step in a method of manufacturing a negative electrode for a battery according to an embodiment of the present disclosure;

FIG. 3 is a schematic cross-sectional view showing a state in which an adhesive is impregnated in a pinhole in a suctioning step in the manufacturing process of the negative electrode for batteries according to the embodiment of the present disclosure; and

FIG. 4 is a schematic cross-sectional view showing a state in which an adhesive is impregnated in a pinhole in a suctioning step in a method for manufacturing a negative electrode for a battery according to an embodiment of the present disclosure.

### DETAILED DESCRIPTION OF EMBODIMENTS

An embodiment which is an example of the present disclosure will be described. These descriptions and examples are illustrative of the embodiments and are not intended to limit the scope of the disclosure. In the present specification, a numerical range expressed by using “from” means a range including these numerical values as a lower limit value and an upper limit value. In the numerical ranges described in the present specification in a stepwise manner, the upper limit value of a stepwise numerical range may be replaced with the upper limit value of another stepwise numerical range, or may be replaced with the value shown in the examples. Also, the lower limit of a stepwise numerical range may be replaced by the lower limit of another stepwise numerical range, or may be replaced by the values shown in the examples. In the content, “%” means “% by mass” unless otherwise specified.

Each component may contain a plurality of corresponding substances. When referring to the amount of each component in a composition, when a plurality of substances corresponding to each component are present in the composition, unless otherwise specified, the total amount of the plurality of substances present in the composition is meant. “Process” is included in this term not only as an independent process, but also as long as the desired action of the process is achieved even if it cannot be clearly distinguished from other processes.

### Method of Manufacturing Current Collector Foil

A method of manufacturing a current collector foil according to an embodiment of the present disclosure is a method of manufacturing a current collector foil for a liquid-based battery (that is, a battery having an electrolyte as an electrolyte) by bonding a first electrode foil having a pinhole and a second electrode foil. Note that one of the first electrode foil and the second electrode foil is a positive electrode foil and the other is a negative electrode foil. The method of manufacturing a current collector foil includes the following steps (1) to (4).
(1) Application step of applying an adhesive to the first electrode foil
(2) A suctioning step of sucking from a surface side opposite to a surface to which an adhesive is applied in the first electrode foil and impregnating the pinhole with an adhesive
(3) Drying step to dry the adhesive
(4) A heat welding step of bonding the first electrode foil to the surface to which the adhesive is applied and thermally welding the second electrode foil

In the method of manufacturing a current collector foil according to the embodiment of the present disclosure, the number of pinholes in the current collector foil can be reduced by including a suctioning step between the application step and the drying step as described above. As a result, when the current collector foil is used in a liquid-based battery, generation of a through-hole generated in the current collector foil can be suppressed, and occurrence of liquid junction in the liquid-based battery can be suppressed.

Conventionally, a current collector foil in which a positive electrode foil and a negative electrode foil are bonded together via an adhesive is used. However, in the metal foil used for the positive electrode foil and the negative electrode foil, pinholes (small holes penetrating the metal foil) may occur in the manufacturing process.

For example, there is a case where a current collector foil obtained by using a positive electrode foil having a pinhole and bonding the positive electrode foil and the negative electrode foil via an adhesive is used for a liquid-based battery. In this case, there may be a through-hole that penetrates all of the positive electrode foil, the adhesive layer, and the negative electrode foil at the pinhole in the positive electrode foil. Specifically, in a portion having a pinhole of the positive electrode foil, a hole is also formed in the adhesive layer formed on the pinhole, that is, the pinhole may not be blocked by the adhesive. Then, when the current collector foil obtained by bonding the negative electrode foil to the positive electrode foil and the adhesive layer is used for the liquid-based battery, the electrolytic solution enters the holes penetrating through the positive electrode foil and the adhesive layer, and the electrolytic solution comes into contact with the negative electrode foil. When the battery is repeatedly charged and discharged in this condition, a hole may also be formed in the negative electrode foil due to a reaction with the electrolyte solution (for example, a reaction of Cu→Cu²⁺+2e⁻ when copper foil is used as the negative electrode foil). As a result, a through-hole that completely penetrates the positive electrode foil, the adhesive layer, and the negative electrode foil is formed. In addition, there is a case where a current collector foil obtained by using a negative electrode foil having a pinhole and bonding the negative electrode foil and the positive electrode foil via an adhesive is used for a liquid-based battery. In this case, there may be a through-hole that penetrates all of the positive electrode foil, the adhesive layer, and the negative electrode foil at the pinhole in the positive electrode foil. Specifically, in a portion having a pinhole of the negative electrode foil, a hole is also formed in the adhesive layer formed on the pinhole, that is, the pinhole may not be blocked by the adhesive. Then, when the current collector foil obtained by bonding the positive electrode foil to the negative electrode foil and the adhesive layer is used for the liquid-based battery, the electrolytic solution enters the hole penetrating through the negative electrode foil and the adhesive layer, and the electrolytic solution comes into contact with the positive electrode foil. When the battery is repeatedly charged and discharged in this state, cracks may occur in the positive electrode foil, and as a result, a through hole is formed that completely penetrates the negative electrode foil, the adhesive layer, and the positive electrode foil.

Then, in the current collector foil in which the through-holes penetrating the positive electrode foil, the adhesive layer, and the negative electrode foil are formed, one side of the current collector foil and the other side of the current collector foil communicate with each other through the through-holes, so that liquid junction occurs.

Therefore, in the method of manufacturing a current collector foil according to the embodiment of the present disclosure, after the adhesive is applied to the first electrode foil and before the adhesive is dried, a suctioning step of performing suction from the surface side of the first electrode foil opposite to the surface to which the adhesive is applied is provided. By this suctioning step, the pinhole in the first electrode foil is impregnated with the adhesive before drying (i.e., in liquid form), and the pinhole can be filled. Accordingly, even when the current collector foil is used for the liquid-based battery, the electrolytic solution is prevented from entering the pinhole of the first electrode foil, and the through-hole that completely penetrates the positive electrode foil, the adhesive layer, and the negative electrode foil is prevented from being formed. As a result, the occurrence of liquid junction in the liquid-based battery can be suppressed.

An aspect of a method of manufacturing a current collector foil according to an embodiment of the present disclosure will now be described in detail with reference to the drawings.

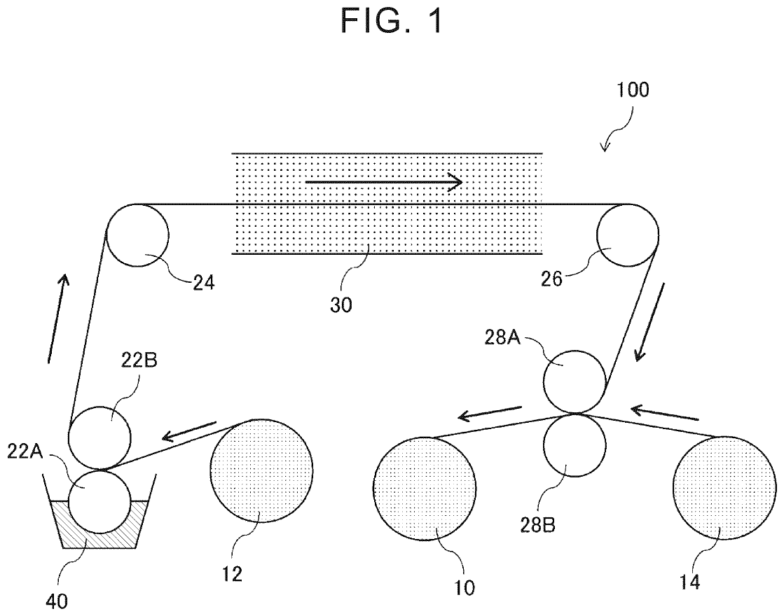

FIG. 1 is a schematic diagram illustrating a current collector foil manufacturing device that implements a method of manufacturing a current collector foil according to an embodiment of the present disclosure. The current collector foil manufacturing device 100 shown in FIG. 1 includes a positive electrode foil 12 (for example, an Al foil) as an example of a first electrode foil formed in a roll shape, and a negative electrode foil 14 (for example, a Cu foil) as an example of a second electrode foil formed in a roll shape. The positive electrode foil 12 is a metal foil having a pinhole.

### (1) Application Step

First, the positive electrode foil 12 is conveyed to a roll pair formed of a coating roll 22A (for example, a gravure roll) and a counter roll 22B. A part of the coating roll 22A is immersed in the adhesive 40, and the adhesive 40 adhered to the surface of the coating roll 22A is applied (for example, gravure applied) to one surface of the positive electrode foil 12 from the coating roll 22A.

### (2) Suctioning Step

Next, the positive electrode foil 12 to which the adhesive 40 is applied on one surface is conveyed to a position in contact with the suction roll 24 as an example of a member having a mechanism for sucking (hereinafter, simply referred to as a “suction member”). The suction roll 24 is disposed at a position in contact with the surface of the positive electrode foil 12 on which the adhesive 40 is not applied. Then, suction is performed by the suction roll 24 from the surface side of the positive electrode foil 12 on which the adhesive 40 is not applied. This allows the positive electrode foil 12 to be impregnated with the adhesive 40 in the empty pinhole.

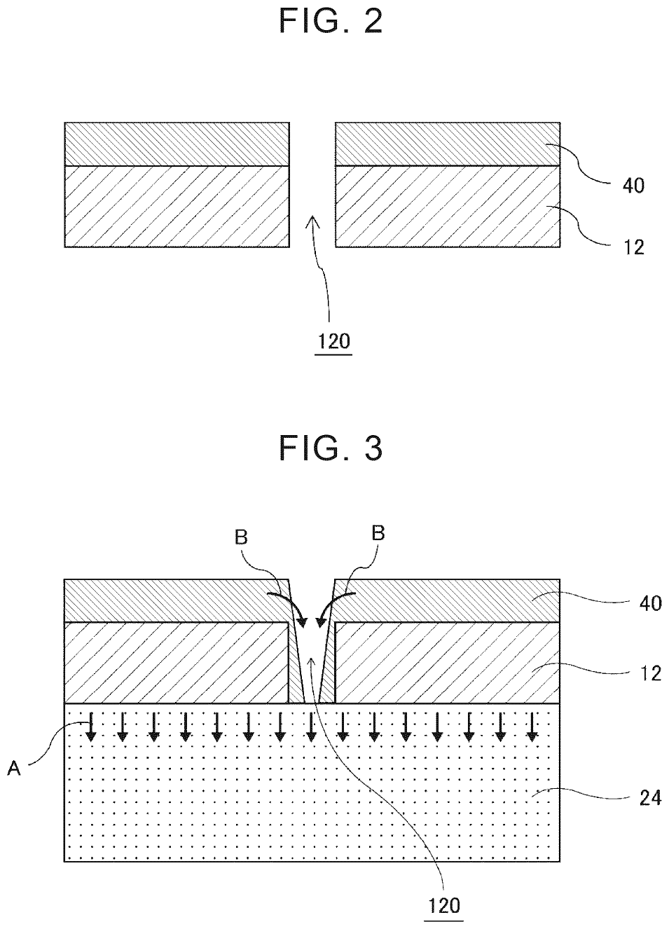

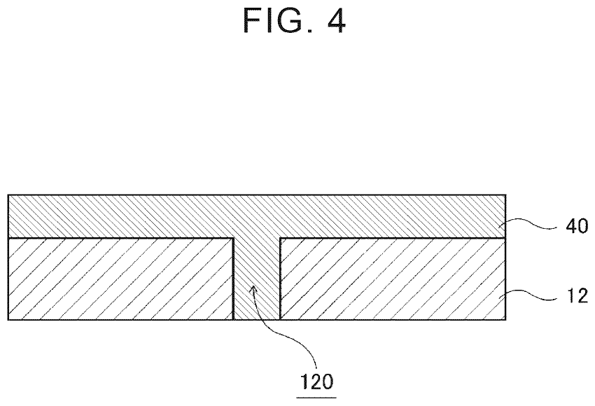

More specifically, as shown in FIG. 2, a hole may also be formed in the adhesive 40 applied on the pinhole 120 at a position where the pinhole 120 is open in the positive electrode foil 12. As shown in FIG. 3, suction is performed on the positive electrode foil 12 from the surface side of the positive electrode foil 12 on which the adhesive 40 is not applied by the suction roll 24 in the arrow A direction. As a result, the inside of the pinhole 120 empty in the positive electrode foil 12 becomes negative pressure, and the adhesive 40 flows in the direction of the arrow B. As a result, as shown in FIG. 4, the adhesive 40 is impregnated into the pinhole 120, and the pinhole 120 is closed.

Here, a suction member such as a suction roll will be described. The suction roll is a roll capable of performing suction from a suction hole provided on the surface. Although the suction roll 24 is illustrated in FIG. 1 as a suction member used in the suctioning step, the present disclosure is not limited thereto. The suction member used in the embodiment of the present disclosure is not particularly limited as long as it is a member capable of performing suction from the surface side of the first electrode foil opposite to the surface to which the adhesive is applied. For example, a belt having a suction hole on a surface thereof (hereinafter referred to as a “suction belt”) may be used.

The diameter of the suction hole (the arithmetic mean of the diameters of the arbitrarily selected 20 suction holes) provided on the surface of the suction member (suction roll 24 in FIG. 1) is preferably not less than 0.5 mm and not more than 15 mm from the viewpoint of making it easier to reduce the number of pinholes in the collector foil. It is more preferably 1.0 mm or more and 10 mm or less. The distance between the suction holes (the distance between the center points of the adjacent suction holes, the arithmetic mean value of the distance between the center points of the arbitrarily selected 20 sets of suction holes) on the surface of the suction member (suction roll 24 in FIG. 1) is preferably not less than 1.0 mm and not more than 20 mm from the viewpoint of making it easier to reduce the number of pinholes in the current collector foil. It is more preferably 2.0 mm or more and 10 mm or less. The suction pressure from the suction hole in the suction member (suction roll 24 in FIG. 1) is preferably 5 kPa or more and 40 kPa or less from the viewpoint of making it easier to reduce the number of pinholes in the current collector foil. It is more preferably 10 kPa or more and 30 kPa or less.

The suction member preferably has a roll shape (for example, suction roll 24 shown in FIG. 1). The holding angle of the roll-shaped suction member (that is, the angle formed by the traveling direction of the first electrode foil on the side away from the suction roll with respect to the traveling direction of the first electrode foil on the side entering the suction roll) is preferably 40° or more and 100° or less from the viewpoint that the number of pinholes in the current collector foil is more easily reduced. It is more preferably 50° or more and 90° or less.

The material of the surface of the suction member (for example, suction roll 24 shown in FIG. 1) having a roll shape is preferably metallic, and particularly preferably SUS. The material of the surface of the suction belt is preferably resin or rubber.

### (3) Drying Step

Next, as shown in FIG. 1, the positive electrode foil 12 having undergone the suctioning step by the suction roll 24 is conveyed to the drying furnace 30, and the adhesive 40 on the positive electrode foil 12 is heated in the drying furnace 30 to be dried.

The heating temperature in the drying step (the temperature in the drying furnace 30 in FIG. 1) can be adjusted by the adhesive used, and is preferably, for example, 80° C. or higher and 200° C. or lower, and more preferably 100° C. or higher and 180° C. or lower.

### (4) Heat Welding Step

Next, the positive electrode foil 12 that has passed through the drying furnace 30 is conveyed to the contacting position with the thermal roll pair 28A, 28B via the conveyance roll 26. In the nip portion of the thermal roll pair 28A, 28B, the negative electrode foil 14 conveyed from another direction is bonded to the surface of the positive electrode foil 12 to which the adhesive 40 is applied. In addition, the positive electrode foil 12 and the negative electrode foil 14 are thermally welded via the adhesive 40 by being heated and pressurized by the thermal roll pair 28A, 28B. Through these steps, the current collector foil 10 in which the positive electrode foil 12 and the negative electrode foil 14 are bonded to each other is manufactured.

The heating temperature in the heat welding step (the temperature of the thermal roll pair 28A, 28B in FIG. 1) can be adjusted by the adhesive used, and is preferably, for example, 50° C. or higher and 150° C. or lower, and more preferably 70° C. or higher and 120° C. or lower. In addition, the pressure applied in the heat welding step (the nip pressure by the thermal roll pair 28A, 28B in FIG. 1) is, for example, preferably 0.20 MPa or more and 0.70 MPa or less. It is more preferably 0.30 MPa or more and 0.60 MPa or less.

Note that, in FIG. 1, a manufacturing method has been described in which the adhesive 40 is applied to the positive electrode foil 12 having a pinhole (application step), and then the negative electrode foil 14 is bonded and thermally welded (heat welding step), but the present disclosure is not limited thereto. That is, it may be a manufacturing method in which an adhesive is applied to a negative electrode foil having a pinhole (application step), and then the positive electrode foil is bonded and thermally welded (heat welding step).

In the method of manufacturing a current collector foil according to the embodiment of the present disclosure, one of the first electrode foil and the second electrode foil is a positive electrode foil, and the other is a negative electrode foil.

As the positive electrode foil to be used, a conductive member made of a metal having good conductivity (for example, aluminum) is preferable. The thickness of the positive electrode foil is, for example, preferably 10 μm or more and 100 μm or less, and more preferably 20 μm or more and 60 μm or less.

On the other hand, as the negative electrode foil, a conductive member made of a metal having good conductivity (for example, copper) is preferable. The thickness of the negative electrode foil is, for example, preferably 1 μm or more and 20 μm or less, and more preferably 3 μm or more and 12 μm or less.

The adhesive used in the method of manufacturing a current collector foil according to the embodiment of the present disclosure is not particularly limited as long as it is a liquid adhesive before the drying step. For example, an adhesive obtained by adding a curing agent (for example, an isocyanate-based curing agent) to a main agent (for example, an olefin-based resin) is preferably used. In addition, a conductive auxiliary agent (for example, Ni plated grains) may be added to the adhesive. The thickness of the adhesive layer formed by applying and drying the adhesive is, for example, 0. It is preferably 5 μm or more and 15 μm or less, more preferably 1.0 μm or more and 10 μm or less.

### Battery

Next, the components constituting the liquid-based battery using the current collector foil obtained by the method of manufacturing a current collector foil according to the embodiment of the present disclosure will be described.

### Positive Electrode Active Material Layer

The positive electrode mixture layer includes a positive electrode active material, and may further include, for example, a binder. Examples of the positive electrode active material include a lithium nickel-cobalt-manganese complex oxide (hereinafter, sometimes simply referred to as “LNCM”). The simplest LNCM is represented by the following general formula: LiNiₓCo_{y}Mn₂O₂ (where x, y, z are 0<x<1, 0<y<1, 0<z<1, x+y+z=1). In addition to Li, Ni, Co, Mn, LNCM may contain other additive elements, such as transition-metal elements other than Ni, Co, Mn, and typical metal elements other than Li. LNCM has a layered crystalline architecture. LNCM may be more than 50% by mass of the entire positive electrode active material, for example, 80 to 100% by mass. The positive electrode active material may be composed only of LNCM. Examples of other positive electrode active materials include a lithium nickel composite oxide, a lithium cobalt composite oxide, and a lithium nickel manganese composite oxide.

Examples of the binder included in the positive electrode mixture layers include vinyl halide resins such as polyvinylidene fluoride (PVdF). The positive electrode mixture layer may further contain other components such as a conductive material. Examples of the conductive material include hardly graphitizable carbon, easily graphitizable carbon such as carbon black, and graphite.

### Anode Active Layer

The negative electrode active material layer described above is used as the negative electrode active material layer. Details have already been described, and therefore will be omitted here.

### Separator

The separator is an electrically insulating porous film. The separator electrically isolates the positive electrode and the negative electrode. The separator may have a thickness of, for example, 5 μm to 30 μm. The separators may be formed of, for example, a porous polyethylene (PE) membrane, a porous polypropylene (PP) membrane, or the like. The separator may have a multilayer structure. For example, the separators may be formed by laminating a porous PP membrane, a porous PE membrane, and a porous PP membrane in this order. The separator may have a heat resistant layer on its surface. The heat resistant layer includes a heat resistant material. Examples of the heat resistant material include metal oxide particles such as alumina, and high melting point resins such as polyimide.

### Electrolytic Solution

A battery according to an embodiment of the present disclosure further includes an electrolytic solution. In particular, a non-aqueous electrolyte solution is preferable.

### Solvent

The non-aqueous electrolyte solution includes a solvent (non-aqueous solvent) and an electrolyte. Examples of the solvent (non-aqueous solvent) include N,N-diethyl-N-methyl-N-(2-methoxyethyl) ammonium bis(fluorosulfonyl)imide (DEME), 1-ethyl-3-methylimidazolium bis(fluorosulfonyl)imide (EMI), and 1-ethyl-2,3-dimethylimidazolium bis(fluorosulfonyl)imide (DEMI-FSI).

### Electrolyte

Examples of the electrolyte in the electrolyte solution include Li. Examples of Li salt include lithium bis(fluorosulfonyl)imide (LiFSI), LiPF₆ (lithium hexafluorophosphate), lithium tetrafluoroborate (LiBF₄), Li[N(CF₃SO₂)₂]. The amount of electrolyte may be, for example, from 1.0 mol/L to 2.0 mol/L, preferably from 1.0 mol/L to 1.5 mol/L.

The electrolyte solution may contain, in addition to the solvent and the electrolyte, various additives such as a thickener, a film forming agent, a gas generating agent, and the like. The electrolyte is typically a liquid non-aqueous electrolyte at room temperature (e.g., 25±10° C.). The electrolyte solution typically exhibits a liquid state in the use environment of the battery (for example, in a temperature environment of −20 to +60° C.).

### Use

Applications of batteries according to the disclosed embodiments include, for example, power supplies such as hybrid electric vehicle (HEV), plug-in hybrid electric vehicle (PHEV), battery electric vehicle (BEV).

Hereinafter, the present disclosure will be described based on Examples, but the present disclosure is not limited to these Examples in any way.

### Adhesive Preparation

An adhesive 1 was obtained by mixing an olefinic resin as a main agent, an isocyanate-based curing agent, and Ni plated particles as a conductive auxiliary agent.

### Preparation of Current Collector Foil

The adhesive 1 was used as the adhesive 40 in the current collector foil manufacturing device 100 shown in FIG. 1, an aluminum foil (Al foil) was used as the positive electrode foil 12, and a copper foil (Cu foil) was used as the negative electrode foil 14. The lining speed (conveyance speed) was set to 15 m/min.

Adhesive 1 was applied to one surface of Al foil by gravure coating (application step). A gravure roll (an elongate, 75 lines) was used as the coating roll 22A.

Next, suction was performed by the suction roll 24 from the surface of Al foil opposite to the surface to which the adhesive 1 was applied under the following conditions (suctioning step).

### Conditions for Suction Roll

Diameter of suction hole: φ2 mm
Spacing of suction holes (distance between center points of suction holes): 4 mm
Suction pressure: 20 kPa
Suction roll holding angle: 50° to 90° Suction Roll Material: SUS

Next, the adhesive 1 was dried by passing through a drying furnace 30 having a temperature set at 150° C. (drying step). Thereafter, Cu foil was bonded to the surface to which the adhesive 1 was applied to Al foil conveyed to the thermal roll pair 28A, 28B and thermally welded (heat welding step), thereby obtaining the current collector foil of the example. The thermal roll pair 28A, 28B was as follows.
Temperature of the thermal roll pair: 90° C.
Nip pressure of the thermal roll pair: 0.45 MPa

### Comparative Example

A current collector foil of the comparative example was obtained in the same manner as in Example 1 except that the suction roll 24 in the current collector foil manufacturing device 100 shown in FIG. 1 was changed to a SUS roll having no mechanism for sucking, that is, the suctioning step was not performed.

### Evaluation Test

### Pinhole Inspection

The presence or absence of pinholes having a diameter of 0.5 mm or less was detected for each of the current collector foils obtained in Examples and Comparative Examples using an inspector. The results are shown in Table 1 below.

TABLE 1

| | Pinhole (number) | | | | |
|---|---|---|---|---|---|
| | Over 0.1 | More than | More than | More than | |
| | mm | 50 μm | 20 μm | 10 μm | |
| | 0.5 mm or | 0.1 mm or | 50 μm or | 20 μm or | 10 μm or |
| | less | less | less | less | less |
| Examples | 0 | 0 | 0 | 0 | 0 |
| Comparative | 0 | 8 | 9 | 3 | 0 |
| Example | | | | | |

It can be seen that in the current collector foil of the example in which suction is performed by the suction roll 24 after application of the adhesive 1, the number of pinholes can be reduced as compared with the current collector foil of the comparative example in which suction is not performed.

What is claimed is:

1. A method of manufacturing a current collector foil for a liquid-based battery by bonding a first electrode foil having pinholes and a second electrode foil, one of the first electrode foil and the second electrode foil being a positive electrode foil and another being a negative electrode foil, the method comprising:
an application step of applying an adhesive to the first electrode foil;
a suctioning step of impregnating the pinholes with the adhesive by performing suctioning from a surface side opposite to a surface of the first electrode foil to which the adhesive has been applied;
a drying step of drying the adhesive; and
a heat welding step of performing heat welding by bonding the second electrode foil to the surface of the first electrode foil to which the adhesive has been applied.

2. The method of manufacturing a current collector foil according to claim 1, wherein the suctioning step includes performing suctioning with a suction member having suction holes in a surface thereof in contact with the surface side opposite to the surface of the first electrode foil to which the adhesive has been applied.

3. The method of manufacturing a current collector foil according to claim 2, wherein a diameter of the suction holes is 0.5 mm or more and 15 mm or less.

4. The method of manufacturing a current collector foil according to claim 2, wherein a spacing of the suction holes is 1.0 mm or more and 20 mm or less.

5. The method of manufacturing a current collector foil according to claim 2, wherein a pressure of suctioning from the suction holes is 5 kPa or more and 40 kPa or less.
